(19) United States
(12) Patent Application Publication
(10) Pub. No.: US 2026/0169690 A1
(43) Pub. Date: Jun. 18, 2026

(54) SYSTEM AND METHOD FOR TINY MACHINE LEARNING USING BLOCK FLOATING POINT

(71) Applicant: Hong Kong Applied Science and Technology Research Institute Company Limited, Hong Kong (HK)

(72) Inventors: Chi Wai NG, Hong Kong (HK); Suk Ling LI, Hong Kong (HK); Pei Fung LAM, Hong Kong (HK)

(21) Appl. No.: 19/090,934

(22) Filed: Mar. 26, 2025

Related U.S. Application Data
(60) Provisional application No. 63/734,188, filed on Dec. 16, 2024.

(51) Int. Cl. G06F 7/483

(52) U.S. Cl. CPC G06F 7/483

(57) ABSTRACT

A system includes a first FP-to-BFP converter, a second FP-to-BFP converter, an 8-bit integer multiplier, an adder, an accumulator, and a BFP-to-FP converter. The first and second FP-to-BFP converters receive 32-bit floating-point pixel and filter data, respectively, reducing their mantissas to 8-bit BFP format. The 8-bit integer multiplier processes these BFP values via multiply-accumulate operations, generating a 16-bit product. The adder accumulates multiple 16-bit products into a 64-bit sum, which the accumulator further aggregates. The BFP-to-FP converter transforms the 64-bit accumulated sum into a 32-bit floating-point output.

### CROSS-REFERENCE TO RELEVANT APPLICATIONS

The present application claims priority from a U.S. provisional patent application Ser. No. 63/734,188 filed Dec. 16, 2024, and the disclosure of which are incorporated by reference in their entirety.

### TECHNICAL FIELD

The present invention relates to a system and method for efficiently executing deep learning models on resource-constrained hardware.

### BACKGROUND

In the context of smart cities and smart homes, Internet-of-things (IoT) devices serve as essential factors in enabling real-time artificial intelligence (AI)-driven automation. However, most AI applications require extensive hardware resources, including high computational power, high data communication bandwidth, and large memory. Due to the resource constraints of IoT devices, many AI applications rely on cloud-based services to handle computationally intensive tasks. Such cloud dependency introduces significant drawbacks, such as increased latency, which is undesirable for real-time applications, and privacy concerns related to transmitting sensitive data over networks.

To address these limitations, efficient AI acceleration techniques are important for enabling on-device inference in IoT systems. The challenge lies in reducing the computational and memory overhead of machine learning or deep learning model inference, particularly in resource-limited environments. For example, conventional floating-point arithmetic imposes high computation and memory demands, making it inefficient for IoT applications.

Block Floating Point (BFP) arithmetic provides a solution by reducing computational complexity and lowering memory bandwidth requirements. However, existing implementations may still face challenges related to hardware efficiency and compatibility with modern deep learning architectures. Accordingly, there is a need for an optimized system and method that effectively integrates BFP arithmetic into machine learning frameworks.

### SUMMARY OF INVENTION

In accordance with a first aspect of the present invention, a system for executing deep learning model computations is provided. The system includes a first floating-point to block floating-point (FP-to-BFP) converter, a second FP-to-BFP converter, an 8-bit integer multiplier, an adder, an accumulator, and block floating-point to floating-point (BFP-to-FP) converter. The first FP-to-BFP converter is configured to receive pixel data in a 32-bit floating-point format and convert the pixel data by reducing a mantissa of the pixel data to 8 bits, thereby obtaining a block floating-point (BFP) format with an 8-bit mantissa. The second FP-to-BFP converter is configured to receive filter data in a 32-bit floating-point format and convert the filter data by reducing a mantissa of the filter data to 8 bits, thereby obtaining a BFP format with an 8-bit mantissa; The 8-bit integer multiplier is configured to receive BFP representations from the first FP-to-BFP converter and the second FP-to-BFP converter and to perform multiply-accumulate operations to generate a 16-bit product. The adder is configured to receive the 16-bit product from the 8-bit integer multiplier and to accumulate multiple 16-bit products, thereby generating a 64-bit accumulated sum. The accumulator is configured to receive the 64-bit accumulated sum from the adder and to aggregate accumulated sums. The BFP-to-FP converter is configured to receive the 64-bit accumulated sum from the accumulator and convert the 64-bit accumulated sum into a 32-bit floating-point output.

In accordance with a second aspect of the present invention, a method for converting floating-point data to BFP format is provided. The method includes steps as follows: receiving, by a FP-to-BFP converter, data in a 32-bit floating-point format; determining, by the FP-to-BFP converter, a shared exponent for a block of floating-point values as the maximum exponent among all the floating-point values in the block; computing, by the FP-to-BFP converter, a right-shift amount for each of the floating-point values based on the difference between its original exponent and the determined shared exponent; applying, by the FP-to-BFP converter, a right shift to mantissa of each of the floating-point values; and truncating, by the FP-to-BFP converter, the 24-bit mantissa of each floating-point value to 8 bits to obtain a BFP format.

In accordance with a third aspect of the present invention, a tiny machine learning (ML) platform is provided. The tiny ML platform includes a tiny ML operations accelerator, a single instruction multiple data multiply-accumulate (SIMD MAC) accelerator, a microcontroller unit (MCU) core, a memory, and a multiplexer (MUX). The tiny ML operations accelerator is configured to execute convolutional neural network (CNN) operations using approximate computing techniques. The tiny ML operations accelerator includes a first FP-to-BFP converter, a second FP-to-BFP converter, and an 8-bit integer multiplier. The first FP-to-BFP converter is configured to receive pixel data in a 32-bit floating-point format and convert the pixel data by reducing a mantissa of the pixel data to 8 bits, thereby obtaining a BFP format with an 8-bit mantissa. The second FP-to-BFP converter is configured to receive filter data in a 32-bit floating-point format and convert the filter data by reducing a mantissa of the filter data to 8 bits, thereby obtaining a BFP format with an 8-bit mantissa. The 8-bit integer multiplier is configured to receive BFP representations from the first FP-to-BFP converter and the second FP-to-BFP converter and to perform multiply-accumulate (MAC) operations to generate a 16-bit product. The SIMD MAC accelerator is coupled to the tiny ML operations accelerator and is configured to perform signal feature extraction and enhance vectorized execution of CNN computations. The MCU core is configured to manage execution control, memory access, and coordination between the tiny ML operations accelerator and the SIMD MAC accelerator. The memory is coupled to the MCU core, the tiny ML operations accelerator, and the SIMD MAC accelerator. The MUX is configured to dynamically route data between the MCU core, the memory, the tiny ML operations accelerator, and the SIMD MAC accelerator.

### BRIEF DESCRIPTION OF DRAWINGS

Embodiments of the invention are described in more details hereinafter with reference to the drawings, in which:

FIG. 1A illustrates the architecture of a system for executing deep learning model computations according to some embodiments of the present invention;

FIG. 1B illustrates how one-dimensional input data is transformed into a two-dimensional numerical matrix;

FIGS. 2A and 2B illustrate a conversion process by which an FP-to-BFP converter reduces mantissa to 8 bits according to some embodiments of the present invention;

FIG. 3 illustrates the process flow of the main arithmetic operations in the convolution layer when the basic data type FP32 is converted to BFP; and

FIG. 4 is a schematic diagram illustrating the architecture of a tiny machine learning platform according to some embodiments of the present invention.

### DETAILED DESCRIPTION OF THE INVENTION

In the following description, systems and methods for tiny machine learning using block floating point and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

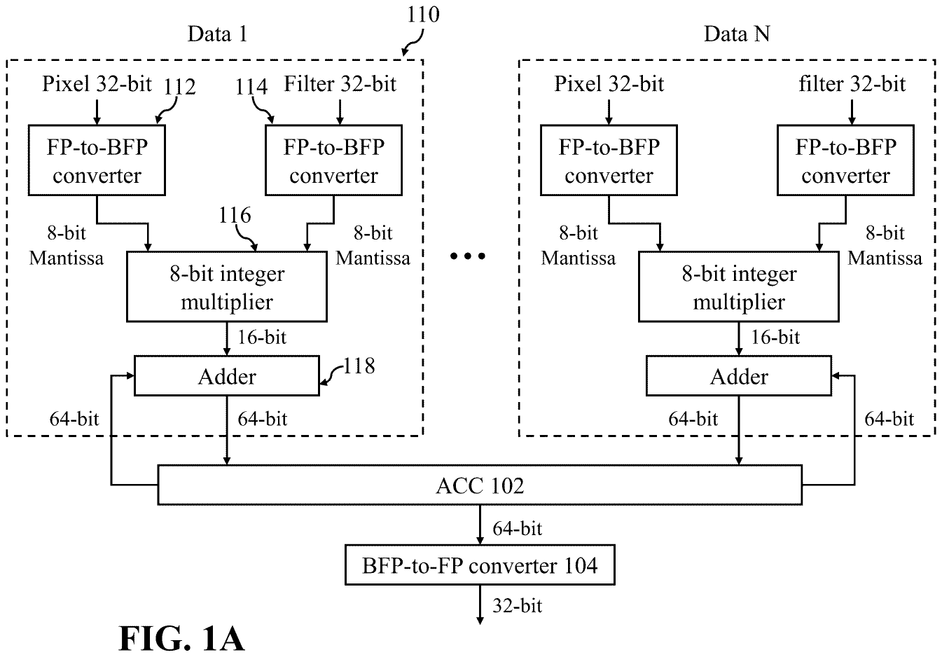

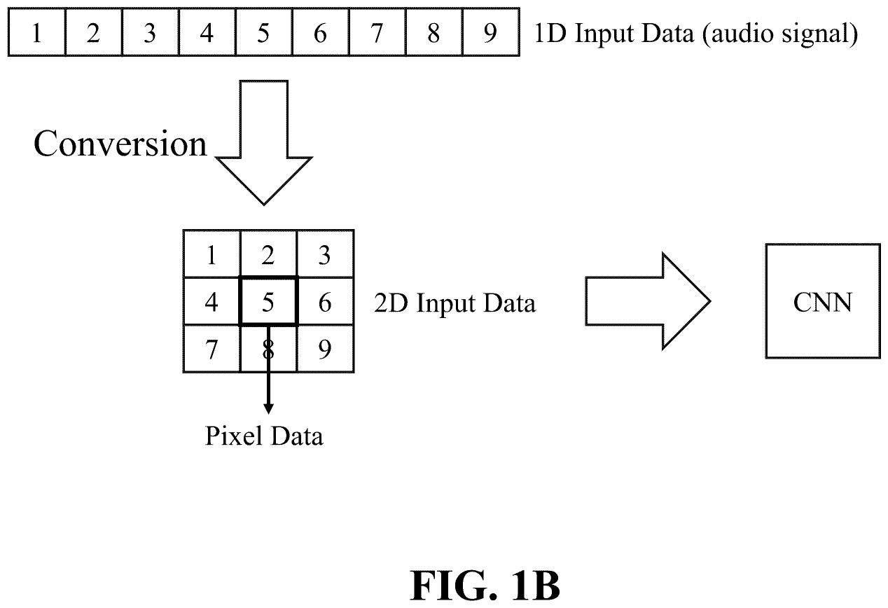

Referring to FIG. 1A for the following description. The architecture illustrated in FIG. 1A is configured to optimize the execution of deep learning/machine learning models (i.e., convolutional neural networks (CNNs)), which involve extensive floating-point multiplication operations. To enhance computational efficiency, the system 100 incorporates a block floating point (BFP) algorithm, which reduces the complexity of these multiplications by enabling multiple data points within a block to share a common exponent. The applied architecture decreases the computational overhead and memory bandwidth requirements, making it particularly suitable for low-power AI applications, such as Tiny Machine Learning (Tiny ML) and edge-based neural network inference.

The system 100 includes multiple processing units 110, an accumulator (ACC) 102, and a block floating-point to floating-point converter (BFP-to-FP converter) 104. The multiple processing units 110 are configured for parallel execution, where each processing unit 110 is responsible for handling a distinct data block (i.e., Data 1 to Data N). All the processing units 110 are coupled to the ACC 102, which is configured to perform at least one computational task, such BFP multiply-accumulate (MAC) operations, data accumulation, and feature extraction, optimizing deep learning model execution. The ACC 102 is coupled to the BFP-to-FP converter 104, which is configured to convert 64-bit BFP data into 32-bit floating-point (FP32) format, making it compatible with subsequent processing stages.

The processing unit 110 for executing Data 1 includes a first floating-point to block floating-point (FP-to-BFP) converter 112 and a second FP-to-BFP converter 114, an 8-bit integer multiplier 116, and an adder 118.

The first FP-to-BFP converter 112 is configured to receive pixel data in a 32-bit floating-point format and convert it by reducing the mantissa of the pixel data to 8 bits (i.e., 8-bit fractional representation), thereby obtaining a BFP format with an 8-bit mantissa. The second FP-to-BFP converter 114 is configured to receive filter data in a 32-bit floating-point format and convert it by reducing the mantissa of the filter data to 8 bits (i.e., 8-bit fractional representation), thereby obtaining a BFP format with an 8-bit mantissa.

In one embodiment, the pixel data in a 32-bit floating-point format represents the input pixel data for a CNN, where each pixel is expressed using a 32-bit floating-point representation. Specifically, the input pixel data is converted into a 2D numerical matrix as the input of CNN. For example, FIG. 1B illustrates how one-dimensional input data is transformed into a two-dimensional numerical matrix. The input data is generated from an audio signal and originally represented as a one-dimensional sequence. During the conversion, the one-dimensional sequence is reorganized into a two-dimensional numerical matrix, where each element in the matrix corresponds to a pixel data point derived from the original sequence. In one embodiment, the filter data in a 32-bit floating-point format corresponds to the filter weights used in a CNN convolutional layer. For example, the processing unit 110 may apply a filter (or kernel) implemented as a matrix to perform convolution operations on the input pixel data, thereby extracting meaningful features such as edges, textures, or patterns.

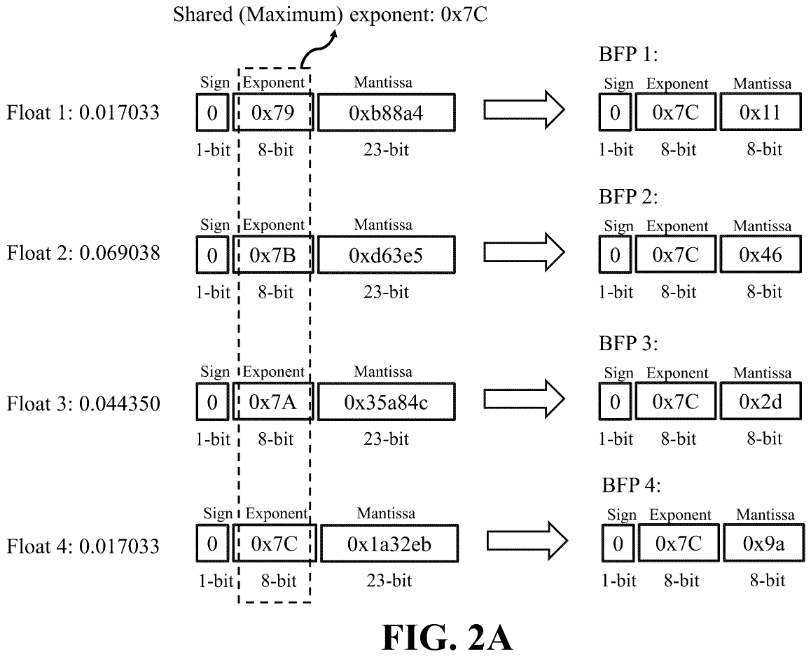

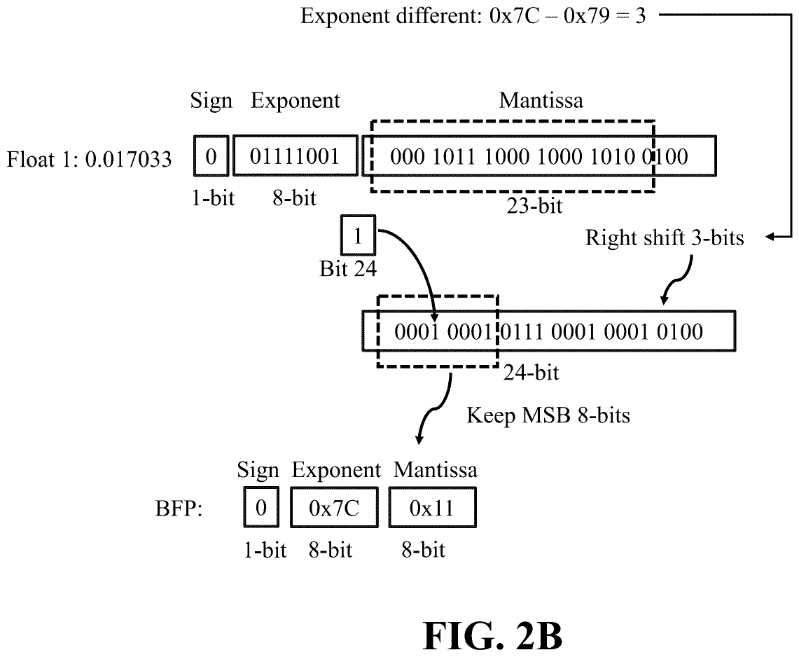

FIGS. 2A and 2B illustrate a conversion process by which an FP-to-BFP converter reduces mantissa to 8 bits according to some embodiments of the present invention.

In FIG. 2A, the first step of the FP-to-BFP conversion involves determining a shared exponent for a block of floating-point values. Each input value in 32-bit floating-point format consists of a sign bit, an 8-bit exponent, and a 23-bit mantissa. Since the BFP format requires multiple values to share a single exponent, the FP-to-BFP converter first scans all the input values within a block and identifies the largest exponent among them. Once the maximum exponent is determined, it is assigned as the shared exponent for the entire block. The first step of the FP-to-BFP conversion allows all values within the block to be aligned under a common exponent, thereby reducing storage requirements and simplifying computation. In this example, the shared maximum exponent is 0x7C, selected from 0x79, 0x7B, 0x7A, and 0x7C.

Then, in FIG. 2B, after determining the shared exponent for the block, the second step of the FP-to-BFP conversion adjusts the mantissa of each floating-point value to align with this exponent. Since the original 32-bit floating-point values have individual exponents, they are normalized to the common exponent during conversion to BFP format.

The FP-to-BFP converter performs mantissa alignment via right-shift. If an input value's original exponent is smaller than the shared exponent, its mantissa must be right shifted by the difference between the two exponents. The shifting allows the value to be properly scaled within the block while maintaining numerical integrity. For example, if the shared exponent is 0x7C, but an input value originally had an exponent of 0x79, its mantissa must be shifted right by (0x7C-0x79)=3 bits to align with the shared exponent.

Furthermore, the FP-to-BFP converter incorporates the hidden leading bit (Bit 24) into the 23-bit mantissa. In the FP32 configuration, the mantissa consists of 23 explicit bits, but there is an implicit leading bit (Bit 24), which is always assumed to be “1” for normalized numbers. Before shifting and truncation, the hidden leading 1-bit is explicitly added to the mantissa, effectively making it a 24-bit value instead of just 23 bits.

Next, the FP-to-BFP converter performs mantissa truncation and precision adjustment. Since the BFP format restricts the mantissa to 8 bits, the adjusted mantissa must be truncated from its expanded 24-bit representation. This process involves selecting the most significant 8 bits of the shifted mantissa while discarding the lower bits. In one embodiment, the discarded bits are rounded to reduce quantization errors, minimizing numerical accuracy loss.

As such, the FP-to-BFP converter constructs the final BFP representation. In one embodiment, the resulting BFP format consists of: 1-bit sign (same as the original floating-point value); 8-bit shared exponent (determined in the first step); and 8-bit truncated mantissa (obtained from the right-shifted and truncated original mantissa). Accordingly, each converted value is stored in a compact 17-bit format (1-bit sign/8-bit exponent/8-bit mantissa), reducing storage and computation requirements compared to the 32-bit floating-point representation. The resulting BFP format enables computation using 8-bit integer multipliers, facilitating efficient processing with reduced hardware complexity.

Referring to FIG. 1A again. The 8-bit integer multiplier 116 is configured to receive the BFP representation with an 8-bit mantissa from the first FP-to-BFP converter 112 and the second FP-to-BFP converter 114, and to perform multiply-accumulate (MAC) operations. In embodiments involving CNN computation, matrix multiplication serves as a fundamental operation, in which pixel data and filter weights undergo element-wise multiplication. The 8-bit integer multiplier 116 facilitates this process by multiplying the BFP mantissa values of pixel data and filter data, producing intermediate results that are subsequently accumulated to generate convolution outputs. By leveraging 8-bit integer arithmetic, the system 100 reduces computational complexity and power consumption compared to 32-bit floating-point multipliers.

The 8-bit integer multiplier 116 produces a 16-bit output representing the product of two 8-bit BFP mantissa values. Specifically, the 8-bit integer multiplier 116 performs multiplication on two 8-bit BFP mantissa values, where one originates from the first FP-to-BFP converter 112 (pixel data) and the other from the second FP-to-BFP converter 114 (filter data). Since each operand is 8 bits, their multiplication results in a 16-bit product.

The adder 118 is configured to receive the 16-bit output from the 8-bit integer multiplier 116 and to perform accumulation operations. Specifically, the adder 118 is configured to sum multiple 16-bit products generated from successive multiplications of BFP mantissa values in the MAC process. As a result, the adder 118 outputs a 64-bit accumulated sum, which represents the intermediate convolution result before further processing, such as exponent adjustment and activation functions.

The processing unit 110 as described above serves as the block for operations on Data 1, while its architecture and processing flow are equally applicable to other instances of processing unit 110 handling different data blocks (i.e., Data N).

All the processing units 110 have their respective adders 118, which are connected to the ACC 102. Each adder 118 accumulates the 16-bit multiplication results and outputs a 64-bit accumulated sum to the ACC 102 for further processing. The ACC 102 is configured to receive and aggregate these accumulated sums from multiple processing units 110, enabling efficient parallel computation. The ACC 102 is further configured to provide a 64-bit feedback signal to the adders 118. The feedback provided by the ACC 102 allows the adders 118 to continue accumulation across multiple cycles, so that partial sums from previous operations are retained and incorporated into subsequent computations. By leveraging the feedback loop from ACC 102, system 100 supports iterative accumulation, enabling handling of large-scale matrix multiplications in CNN operations while maintaining numerical accuracy.

The BFP-to-FP converter 104 is configured to receive the 64-bit accumulated sum from the ACC 102 and convert it into a 32-bit floating-point representation. The conversion by the BFP-to-FP converter 104 involves extracting the shared exponent from the BFP format, adjusting the accumulated mantissa accordingly, and reconstructing the final FP32 output. By performing this conversion/transformation, the BFP-to-FP converter 104 enables compatibility with subsequent processing stages that operate on standard floating-point precision.

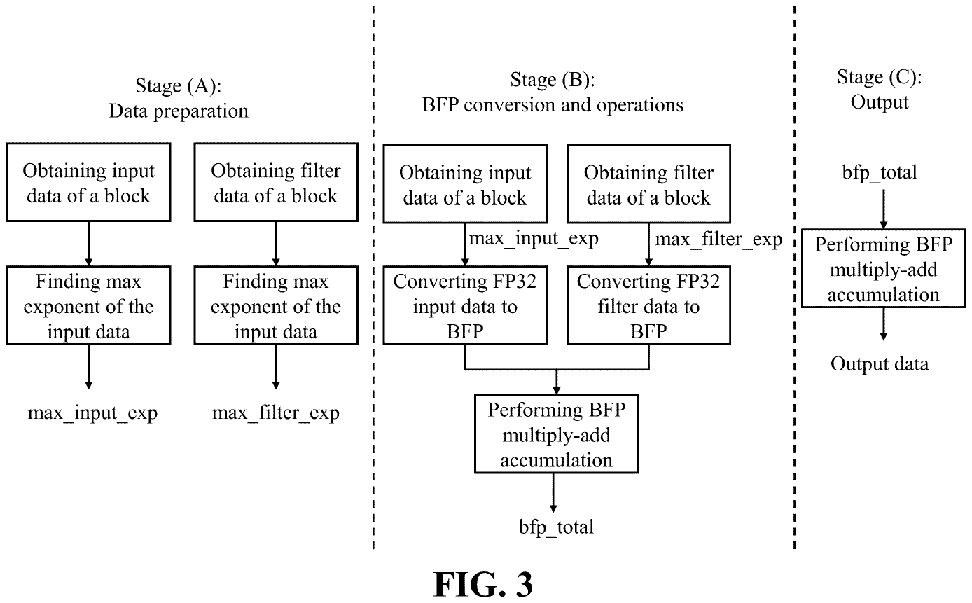

In one embodiment, system 100 is applied to software that serves as a mobile library for deploying models on mobile devices, microcontrollers, and other edge devices. FIG. 3 illustrates the software flow of the main arithmetic operations in the convolution layer when the basic data type FP32 is converted to BFP. The flow is divided into three stages: Data Preparation (Stage A), BFP Conversion and Operations (Stage B), and Output (Stage C).

In Stage A, the system 100 processes blocks of input data (i.e., pixel data) and filter data (i.e., weight data) in FP32 format. The first FP-to-BFP converter 112 is configured to receive pixel data, while the second FP-to-BFP converter 114 receives filter data. Each FP-to-BFP converter identifies the maximum exponent within a block of values, referred to as “max_input_exp” for input data and “max_filter_exp” for filter data. The Stage A allows all data points within a block to share a common exponent, which is necessary for BFP conversion, reducing memory bandwidth and computational complexity.

In Stage B, the system 100 converts the FP32 input data and filter data into BFP format using the shared exponents determined in Stage A. The first FP-to-BFP converter 112 converts the pixel data to BFP representation, and the second FP-to-BFP converter 114 does the same for filter data. Once the data is in BFP format, the system 100 performs BFP multiply-add accumulation, where the 8-bit integer multiplier 116 executes element-wise multiplication of 8-bit BFP mantissas from the pixel data and the filter data, producing a 16-bit product. The product results are then passed to the adder 118, which performs iterative accumulation, generating a 64-bit accumulated sum. The accumulated result is referred to as “bfp_total,” which will be further processed in Stage C.

In Stage C, the system 100 finalizes the computation by processing “bfp_total” and converting the accumulated result back to floating-point format. The adder 118 continues the BFP multiply-add accumulation, and the 64-bit accumulated sum (i.e., “bfp_total”) from the multiple processing units 110 is transferred to the ACC 102, which is configured to aggregate and manage accumulated sums from parallel computations.

As afore described, the ACC 102 facilitates efficient handling of large-scale CNN matrix multiplications by coordinating accumulation across the multiple processing units 110. After accumulation in the ACC 102, “bfp_total” is passed to the BFP-to-FP converter 104, which converts it into FP32. This conversion involves extracting the shared exponent, adjusting the mantissa, and reconstructing the final FP32 output to maintain compatibility with subsequent processing stages, such as activation functions (i.e., ReLU) and pooling layers in CNN computations.

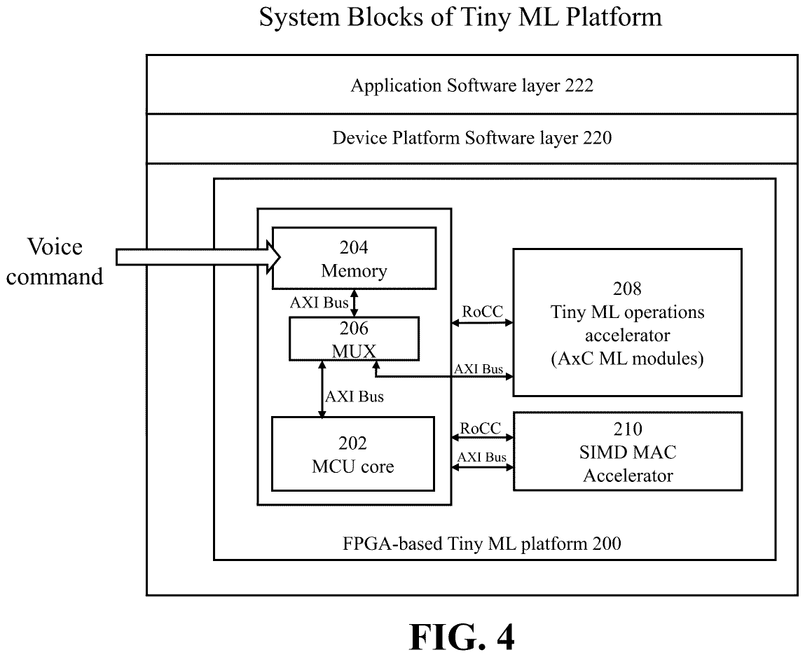

FIG. 4 is a schematic diagram illustrating an architecture of a tiny machine learning (Tiny ML) platform 200 according to some embodiments of the present invention. The configuration of the system 100 is available to apply to the Tiny ML platform 200. The Tiny ML platform 200 is configured to execute lightweight machine learning workloads, leveraging hardware accelerators for optimized neural network inference. The Tiny ML platform 200 includes a microcontroller unit (MCU) core 202, a memory 204, a multiplexer (MUX) 206, a tiny ML operations accelerator 208, and a single instruction multiple data multiply-accumulate (SIMD MAC) accelerator 210. Among these components, interactions occur through an advanced extensible interface (AXI) bus for data transfer and a rocket custom coprocessor (RoCC) interface for control signaling.

The MCU core 202 serves as a central processing unit configured to manage execution control, memory access, and coordination between hardware accelerators. The MCU core 202 interacts with the memory 204, in which the memory 204 stores model parameters, intermediate feature maps, and computation results. The MCU core 202 communicates with the tiny ML operations accelerator 208 and the SIMD MAC accelerator 210 using the RoCC interface, which sends control instructions to direct Tiny ML operations.

The memory 204 acts as a storage unit for model weights, input data, feature maps, and computational results required for Tiny ML inference. The memory 204 connects to both the MCU core 202 and hardware accelerators (i.e., the tiny ML operations accelerator 208 and the SIMD MAC accelerator 210) via the AXI bus.

The MUX 206 functions as a data-routing component configured to control the flow of data among the MCU core 202, memory 204, and the hardware accelerators. Since the tiny ML operations accelerator 208 and the SIMD MAC accelerator 210 specialize in deep learning model (i.e., CNN) computations and signal processing, the MUX 206 dynamically routes data to the appropriate processing unit, improving parallel execution efficiency.

The first and second FP-to-BFP converters 112/114, the integer multipliers 116, and the adders 118 of the processing units 110 in the system 100, as previously described in FIG. 1A, may be applied to the Tiny ML operations accelerator 208 and the SIMD MAC accelerator 210.

For example, the Tiny ML operations accelerator 208 is configured to execute deep learning model operations (i.e., CNN operations) using approximate computing techniques. The Tiny ML operations accelerator 208 includes a configuration that is identical to or similar to the structure established by the first and second FP-to-BFP converters 112/114 of the processing units 110. The Tiny ML operations accelerator 208 is configured to provide BFP computations for CNN workloads, including matrix multiplications, element-wise operations, and activation functions required for CNN inference. By applying the configuration of the processing units 110 to the Tiny ML operations accelerator 208, the Tiny ML operations accelerator 208 transforms floating-point input into BFP format with an 8-bit mantissa. The SIMD MAC accelerator 210 is configured to enhance vectorized execution through SIMD-based MAC operations. The SIMD MAC accelerator 210 includes a configuration that is identical to or similar to the 8-bit integer multipliers 116 and adders 118 of the processing units 110. Accordingly, the SIMD MAC accelerator 210 cooperates with the Tiny ML operations accelerator 208 to facilitate model and network computation, as afore described. The SIMD MAC accelerator 210 is further configured to execute accumulation operations similar to the ACC 102, summing the partial results generated from element-wise multiplications performed by the Tiny ML operations accelerator 208. Once accumulated, these results are stored in the memory 204, making them available for further computations or final output processing.

Regarding the BFP-to-FP conversion process, it might be executed by either the MCU core 202, which manages execution control and data processing, or by a dedicated logic implemented within the Tiny ML operations accelerator 208. After conversion, the FP32 results are stored in the memory 204, where they are to be accessed for activation functions, pooling operations, or further post-processing by the MCU core 202.

A device platform software layer 220 is coupled to the Tiny ML platform 200. In one embodiment, the device platform software layer 220 integrates TensorFlow Lite for MCU, which is a mobile machine learning library optimized for microcontrollers and edge devices. The library is modified to leverage hardware accelerators, enabling efficient execution of CNN inference on constrained hardware. An application software layer 222 is coupled to the device platform software layer 220 and contains ML demo applications running on the Tiny ML platform 200, demonstrating real-world use cases of Tiny ML inference.

The Tiny ML platform 200 in combination with the device platform software layer 220 and the application software layer 222 provides real-life Tiny ML inference tasks, such as voice command processing in an IoT device. In an IoT environment, the Tiny ML platform 200 enables real-time voice command recognition and response, making it suitable for applications in robot cleaners, wearable devices, smart sensors, and electric vehicles.

For example, the process begins when the IoT device receives a voice command from a user (or a source for ultrasound wave). The audio signal is captured by the IoT device's microphone and converted into a digital representation. The MCU core 202 first processes the raw voice data and transfers it to the memory 204, where it is stored temporarily before being sent for feature extraction. The SIMD MAC accelerator 210 performs signal feature extraction to convert the voice data into a form suitable for Tiny ML inference by the Tiny ML Operations accelerator 208.

Once the voice features are extracted, they are passed to the Tiny ML operations accelerator 208, which executes CNN operations using approximate computing techniques. During this process, the voice features are converted from FP32 format to BFP format using FP-to-BFP converters for input data and filter weights. The converted values then undergo BFP multiply-accumulate operations, leveraging the 8-bit integer multiplier and adders to compute matrix multiplications. The accumulator collects and sums up the computed results before passing them to the BFP-to-FP converter, which converts the final output into FP32 format.

In one embodiment, the resulting classification output determines the corresponding IoT device action based on the recognized voice command. For example, if the detected command is “Start Cleaning,” a robot cleaner receives a control signal to initiate the vacuuming process. If the command is “Check Heart Rate,” a wearable device retrieves real-time health data and displays the heart rate on the screen. If the command is “Turn off the lights,” smart sensors send a wireless signal to control smart lighting. If the command is “Activate self-parking,” an electric vehicle interfaces with autonomous driving modules to execute the parking maneuver.

The edge-based processing enables voice recognition to be performed locally on the IoT device, eliminating reliance on cloud-based computation, thereby reducing latency and enhancing privacy. The Tiny ML platform optimizes power-efficient inference, making it well-suited for low-power IoT scenarios. Moreover, the platform reduces memory usage and computational complexity in dot product calculations for block data, enabling a low-cost MCU core. The proposed solution enhances both processing speed and energy efficiency.

In the present disclosure, the matrix operations referenced or involved include dot product of two vectors. Given two vectors, a=[a₁, a₂, . . . , aₙ] and b=[b₁, b₂, . . . , bₙ], the dot product is defined as:

$$a \cdot b = {\sum }_{i = 1}^{n} {a}_{i} {b}_{i} = {a}_{1} {b}_{1} + {a}_{2} {b}_{2} + … + {a}_{n} {b}_{n}$$

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure; for example, an FPGA-based Tiny ML platform, an IC-based Tiny ML platform, or another form of Tiny ML platform. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for executing deep learning model computations, comprising:
a first floating-point to block floating-point (FP-to-BFP) converter configured to receive pixel data in a 32-bit floating-point format and convert the pixel data by reducing a mantissa of the pixel data to 8 bits, thereby obtaining a block floating-point (BFP) format with an 8-bit mantissa;
a second FP-to-BFP converter configured to receive filter data in a 32-bit floating-point format and convert the filter data by reducing a mantissa of the filter data to 8 bits, thereby obtaining a BFP format with an 8-bit mantissa;
an 8-bit integer multiplier configured to receive BFP representations from the first FP-to-BFP converter and the second FP-to-BFP converter and to perform multiply-accumulate operations to generate a 16-bit product;
an adder configured to receive the 16-bit product from the 8-bit integer multiplier and to accumulate multiple 16-bit products, thereby generating a 64-bit accumulated sum;
an accumulator configured to receive the 64-bit accumulated sum from the adder and to aggregate accumulated sums; and
a block floating-point to floating-point (BFP-to-FP) converter configured to receive the 64-bit accumulated sum from the accumulator and convert the 64-bit accumulated sum into a 32-bit floating-point output.

2. The system of claim 1, wherein each of the first FP-to-BFP converter and the second FP-to-BFP converter is further configured to determine a shared exponent for a block of floating-point values before converting the mantissa to 8 bits.

3. The system of claim 2, wherein the shared exponent is determined as a maximum exponent among all floating-point values in the block.

4. The system of claim 3, wherein each of the first FP-to-BFP converter and the second FP-to-BFP converter is further configured to:
compute a right-shift amount for each floating-point value by subtracting its original exponent from the determined maximum exponent; and
apply the computed right shift to the mantissa of each floating-point value to align the floating-point values within the block under the shared exponent before truncating the mantissa to 8 bits.

5. The system of claim 4, wherein each of the first FP-to-BFP converter and the second FP-to-BFP converter is further configured to incorporate a hidden leading bit into the mantissa before performing right-shifting and truncation.

6. The system of claim 5, wherein the right-shifting and truncation by the first FP-to-BFP converter or the second FP-to-BFP converter involve selecting the most significant 8 bits from a right-shifted 24-bit expanded mantissa.

7. The system of claim 1, wherein the BFP format with the 8-bit mantissa comprises a 17-bit representation, comprising a 1-bit sign, an 8-bit shared exponent, and an 8-bit mantissa obtained from the first FP-to-BFP converter or the second FP-to-BFP converter.

8. The system of claim 1, wherein the adder is configured to receive multiple 16-bit products generated from successive multiply-accumulate operations performed by the 8-bit integer multiplier.

9. The system of claim 1, wherein the BFP-to-FP converter is configured to reconstruct a 32-bit floating-point output by extracting a shared exponent and adjusting accumulated mantissa accordingly.

10. The system of claim 1, wherein the 8-bit integer multiplier performs element-wise multiplication of the pixel data and the filter data in a convolutional neural network (CNN).

11. A method for converting floating-point data to block floating-point (BFP) format, comprising:
receiving, by a floating-point to block floating-point (FP-to-BFP) converter, data in a 32-bit floating-point format;
determining, by the FP-to-BFP converter, a shared exponent for a block of floating-point values as the maximum exponent among all the floating-point values in the block;
computing, by the FP-to-BFP converter, a right-shift amount for each of the floating-point values based on the difference between its original exponent and the determined shared exponent;
applying, by the FP-to-BFP converter, a right shift to mantissa of each of the floating-point values; and
truncating, by the FP-to-BFP converter, the 24-bit mantissa of each floating-point value to 8 bits to obtain a BFP format.

12. The method of claim 11, wherein the data in the 32-bit floating-point format is pixel data or filter data for computation for a convolutional neural network (CNN).

13. The method of claim 11, further comprising: incorporating a hidden leading bit into the mantissa before performing right shifting and truncation.

14. The method of claim 13, wherein the right-shifting and truncation involve selecting the most significant 8 bits from a right-shifted 24-bit expanded mantissa.

15. The method of claim 11, wherein the BFP format comprises a 17-bit representation, comprising a 1-bit sign, an 8-bit shared exponent, and an 8-bit mantissa.

16. A tiny machine learning (ML) platform, comprising:
a tiny ML operations accelerator configured to execute convolutional neural network (CNN) operations using approximate computing techniques and comprising:
a first floating-point to block floating-point (FP-to-BFP) converter configured to receive pixel data in a 32-bit floating-point format and convert the pixel data by reducing a mantissa of the pixel data to 8 bits, thereby obtaining a block floating-point (BFP) format with an 8-bit mantissa;
a second FP-to-BFP converter configured to receive filter data in a 32-bit floating-point format and convert the filter data by reducing a mantissa of the filter data to 8 bits, thereby obtaining a BFP format with an 8-bit mantissa; and
an 8-bit integer multiplier configured to receive BFP representations from the first FP-to-BFP converter and the second FP-to-BFP converter and to perform multiply-accumulate (MAC) operations to generate a 16-bit product;
a single instruction multiple data multiply-accumulate (SIMD MAC) accelerator coupled to the tiny ML operations accelerator and configured to perform signal feature extraction and enhance vectorized execution of CNN computations;
a microcontroller unit (MCU) core configured to manage execution control, memory access, and coordination between the tiny ML operations accelerator and the SIMD MAC accelerator;
a memory coupled to the MCU core, the tiny ML operations accelerator, and the SIMD MAC accelerator; and
a multiplexer (MUX) configured to dynamically route data between the MCU core, the memory, the tiny ML operations accelerator, and the SIMD MAC accelerator.

17. The tiny ML platform of claim 16, wherein the SIMD MAC accelerator is further configured to perform signal feature extraction prior to tiny ML inference by processing incoming voice data.

18. The tiny ML platform of claim 16, wherein the tiny ML platform is coupled to a device platform software layer, which is configured to optimize inference execution on microcontrollers and edge devices.

19. The tiny ML platform of claim 16, wherein the tiny ML platform is coupled with a microphone and is configured to receive an audio signal captured by the microphone, so as to convert the audio signal into a digital representation.

20. The tiny ML platform of claim 19, wherein the tiny ML platform is configured to determine a classification output based on a recognized voice command from the audio signal and to generate a control signal to execute an action for a IoT device based on a classification output.
